(19) United States
(12) Patent Application Publication
(10) Pub. No.: US 2008/0079277 A1
(43) Pub. Date: Apr. 3, 2008

(54) Ladder Rack Assembly

(76) Inventor: Brian J. Wethington, Canton Township, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/863,730

(22) Filed: Sep. 28, 2007

Related U.S. Application Data
(60) Provisional application No. 60/847,990, filed on Sep. 28, 2006.

(51) Int. Cl. B60P 1/00

(52) U.S. Cl. 296/3; 224/405

(57) ABSTRACT

A rack assembly for at least partially supporting a ladder in the bed box of a truck is disclosed herein. The rack assembly includes a telescopically erectable and collapsible stanchion assembly, at least one bracket assembly for mounting the bottom of the stanchion assembly to the truck's bed box, and a telescopically extendable and retractable crossbar assembly that is releasably securable at the top of the stanchion assembly. When the rack assembly is not being used, tubular sections of the stanchion assembly can be telescopically collapsed together. Tubular sections of the crossbar assembly can be released from the top of the stanchion assembly and then placed in the collapsed stanchion assembly. In this way, the rack assembly can be stored in a substantially unitary, reduced-volume configuration in the bed box of the truck.

### CROSS REFERENCE TO A RELATED APPLICATION

The present invention claims priority from U.S. Provisional Application Ser. No. 60/847,990, originally entitled “Collapsible and Detachable Mounted Ladder Rack,” which was filed on Sep. 28, 2006.

### FIELD OF THE INVENTION

The present invention generally relates to a rack for supporting and transporting a ladder onboard a vehicle. The present invention more particularly relates to a ladder rack assembly that is collapsible onboard a vehicle.

### BACKGROUND OF THE INVENTION

Ladder racks are frequently mounted in the beds or bed boxes of trucks so that work ladders can be easily supported, secured, and transported onboard trucks without rattling around loose in the trucks' beds while traveling to work sites. When, however, a ladder rack is not being utilized to transport a ladder, it is generally desirable to take the ladder rack down so as to help conserve space in a truck's bed box, or so that a truck bed cover can be placed over the bed box.

After taking down a ladder rack, however, the demounted ladder rack often undesirably takes up floor space in a truck's bed box, and the ladder rack often rattles around loosely in the truck's bed while driving. To help remedy such problems, some conventional ladder racks have been designed so that they can be partially collapsed while still remaining mounted to a truck's bed. Though such conventional ladder racks do help conserve some floor space in a truck's bed box and also reduce rattle, such ladder racks often cannot be collapsed down low enough to permit a truck bed cover to be mounted over a bed box. Also, such ladder racks often undesirably require that their crossbar assemblies still be detached and laid loosely in a truck's bed.

In view of the above, there is a present need in the art for a ladder rack assembly that can be collapsed and stored in a substantially unitary, secure, and reduced-volume configuration in the bed box of a truck.

### SUMMARY OF THE INVENTION

The present invention provides a rack assembly for at least partially supporting a ladder in the bed box of a truck. In one embodiment, the rack assembly includes a telescopically erectable and collapsible stanchion assembly, at least one bracket assembly for mounting the bottom of the stanchion assembly to the truck's bed box, and a telescopically extendable and retractable crossbar assembly that is releasably securable at the top of the stanchion assembly. When the rack assembly is not being used, tubular sections of the stanchion assembly can be telescopically collapsed together. Tubular sections of the crossbar assembly can be released from the top of the stanchion assembly and then placed in the collapsed stanchion assembly. In this way, the rack assembly can be stored in a substantially unitary, reduced-volume configuration in the bed box of the truck.

Furthermore, it is believed that various alternative embodiments of the present invention will become apparent to those skilled in the art when the detailed description of the best mode(s) contemplated for practicing the present invention, as set forth hereinbelow, is reviewed in conjunction with the appended claims and the accompanying drawing figures.

### BRIEF DESCRIPTION OF THE DRAWINGS

The present invention is described hereinbelow, by way of example, with reference to the following drawing figures.

FIG. 1 illustrates a perspective view of a truck's bed box that includes two rack assemblies for supporting a ladder. As shown, each rack assembly includes a stanchion assembly and a crossbar assembly secured thereto.

FIGS. 2A and 2B respectively illustrate perspective and rear views of one stanchion assembly, therein highlighting how the stanchion assembly is mounted to the truck's bed box.

FIG. 3 illustrates a threaded spring pin, which is utile for tightening tubular sections of the stanchion assembly together.

FIG. 4 illustrates an alternative embodiment in which a supplemental tightening bolt is utilized along with the threaded spring pin of FIG. 3 to help tighten tubular sections of the stanchion assembly together.

FIGS. 5A, 5B, and 5C respectively illustrate front, side, and top views of the top end of one stanchion assembly with its associated crossbar assembly removed therefrom.

FIG. 6 illustrates both the first tubular section and the second tubular section of one crossbar assembly.

FIG. 7 illustrates a perspective view of the two rack assemblies of FIG. 1 in which their respective stanchion assemblies are collapsed and the tubular sections of their associated crossbar assemblies are respectively placed in the collapsed stanchion assemblies.

### LIST OF PARTS AND FEATURES

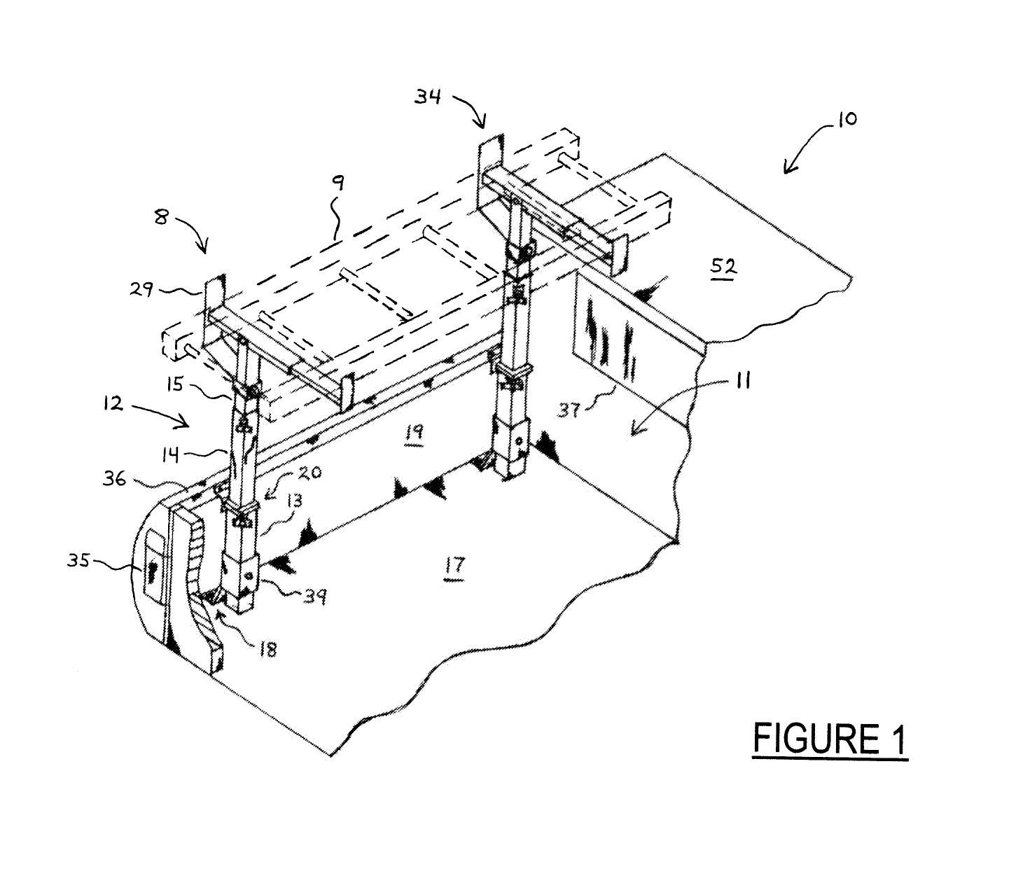

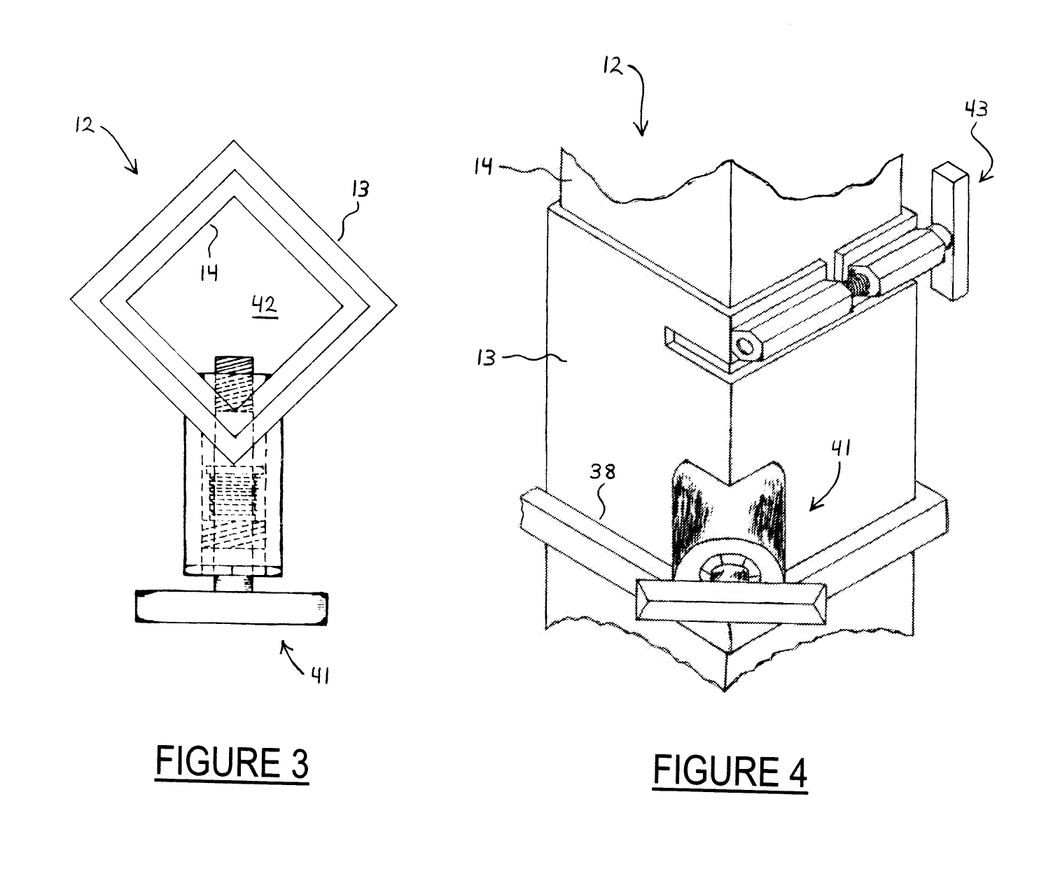

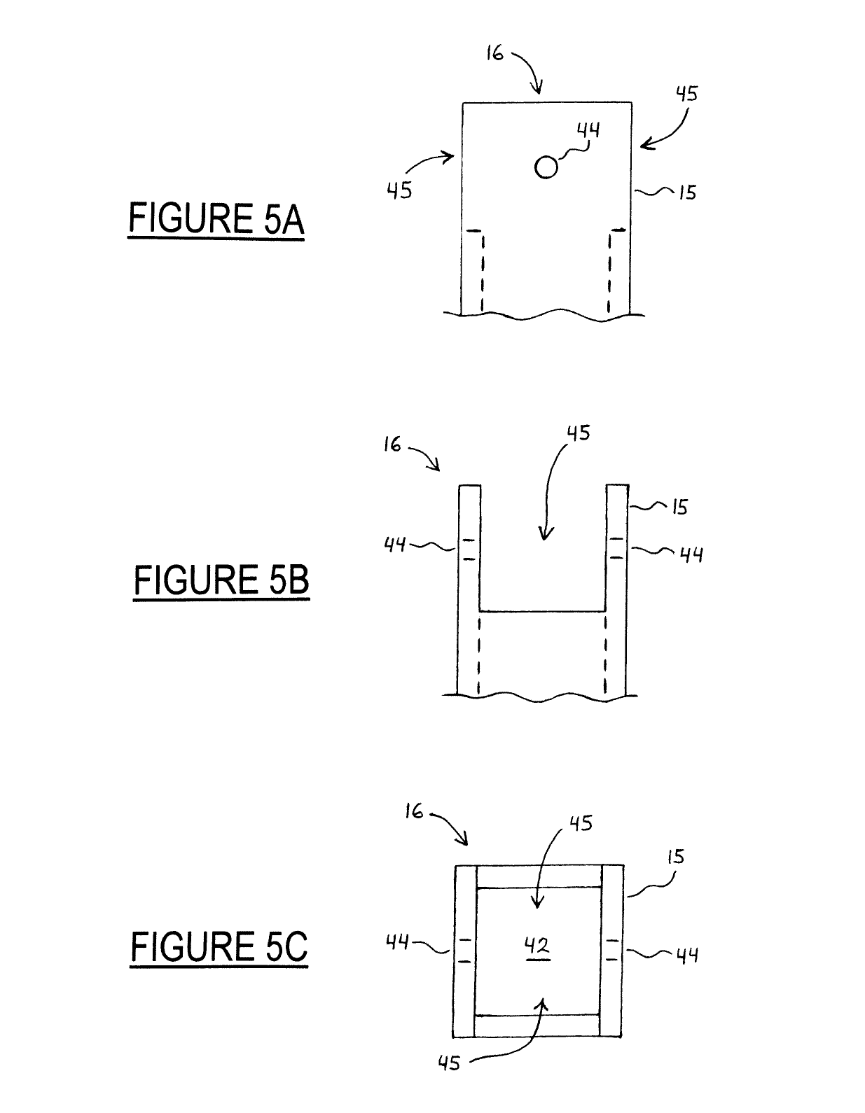

To facilitate an understanding of the present invention, a list of parts and features highlighted with numeric designations in FIGS. 1 through 7 is set forth hereinbelow.
8 rack assembly (for at least partially supporting a ladder)
9 ladder
10 truck
11 bed box (of truck)
12 stanchion assembly (telescopically erectable and collapsible)
13 bottom tubular section (of stanchion assembly)
14 middle tubular section (of stanchion assembly)
15 top tubular section (of stanchion assembly)
16 top end (of top tubular section)
17 floor (of bed box)
18 first bracket assembly (for mounting bottom tubular section to floor)
19 sidewall (of bed box)
20 second bracket assembly (for mounting bottom tubular section to sidewall)
21 crossbar assembly (telescopically extendable and retractable)
22 first tubular section (of crossbar assembly)
23 first end (of first tubular section)
24 second end (of first tubular section)
25 second tubular section (of crossbar assembly)
26 first end (of second tubular section)
27 second end (of second tubular section)
28 attachment section (of first tubular section)
29 flange (on first tubular section)
30 opening (defined through flange)
31 complementary flange (on second tubular section)
32 arm extension (on flange)
33 distal end (of arm extension)
34 complementary rack assembly (for at least partially supporting a ladder)
35 tail light (of truck)
36 top edge (of bed box)
37 rear cabin window (of truck)
38 u-bolt (of bracket assembly)
39 square tubing weldment (of bracket assembly)
40 compression bolt
41 threaded spring pin
42 inner hollow (of stanchion assembly)
43 supplemental tightening bolt
44 hole(s) (in top end for receiving a spring pin)
45 slot(s) (in top end for receiving the crossbar assembly)
46 collar (for receiving the top tubular section)
47 compression bolt (in collar)
48 hole(s) (in first tubular section for receiving a spring pin)
49 hole(s) (in first tubular section for receiving a pin)
50 hole(s) (in second tubular section for receiving a pin)
51 inner hollow (of crossbar assembly)
52 cabin roof (of truck)

### DETAILED DESCRIPTION OF THE INVENTION

FIGS. 1 through 7 illustrate various views of one embodiment of a rack assembly 8 according to the present invention. In general, the rack assembly 8 is utile for at least partially supporting a ladder 9 in the bed box 11 of a truck 10. As shown, the rack assembly 8 includes a stanchion assembly 12, a first bracket assembly 18, a second bracket assembly 20, and a crossbar assembly 21.

The stanchion assembly 12 is telescopically erectable and collapsible. In general, the stanchion assembly 12 has a bottom tubular section 13, a middle tubular section 14, and a top tubular section 15. The top tubular section 15 has a top end 16 that is substantially open and hollow.

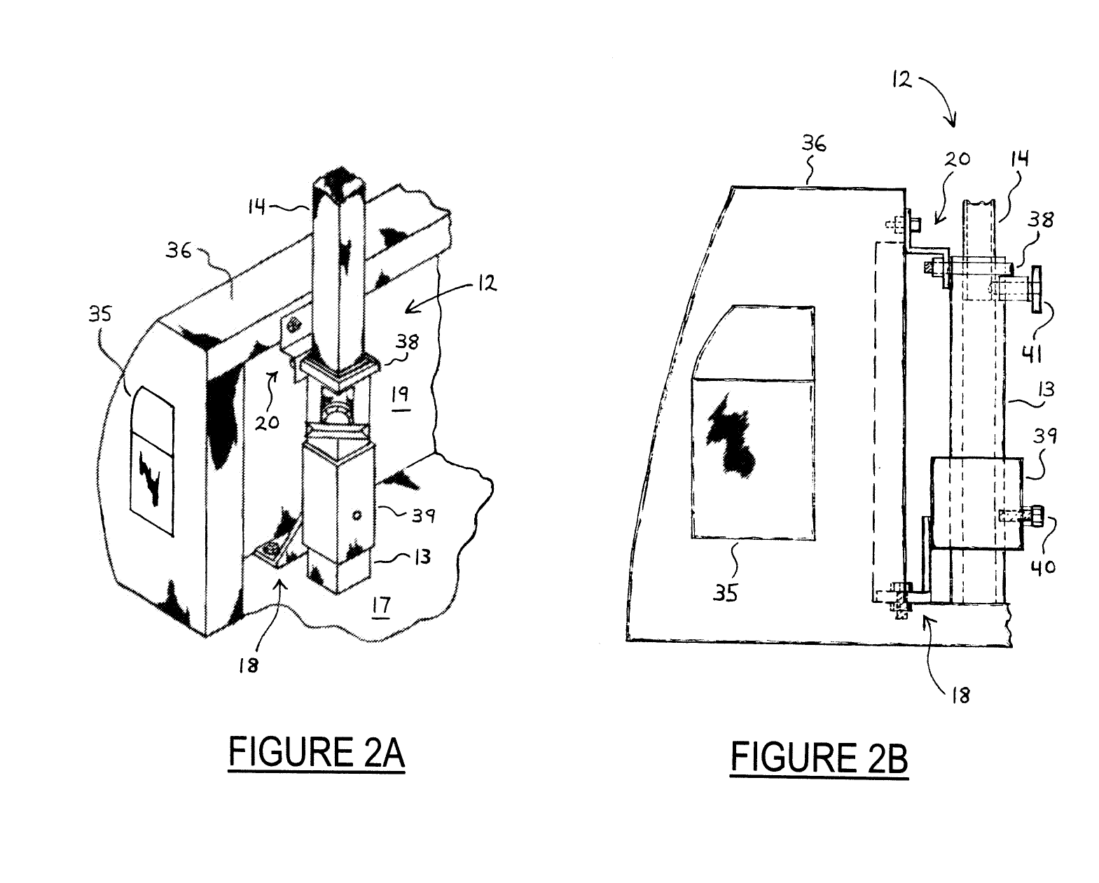

The first bracket assembly 18 is adapted for mounting the bottom tubular section 13 of the stanchion assembly 12 to the floor 17 of the truck's bed box 11. As best shown in FIGS. 2A and 2B, the first bracket assembly 18 particularly includes both a square tubing weldment 39 and a compression bolt 40 to accomplish such. The second bracket assembly 20, on the other hand, is adapted for mounting the bottom tubular section 13 of the stanchion assembly 12 to a sidewall 19 of the truck's bed box 11. To accomplish such, the second bracket assembly 20 particularly includes a u-bolt 38 along with a threaded spring pin 41.

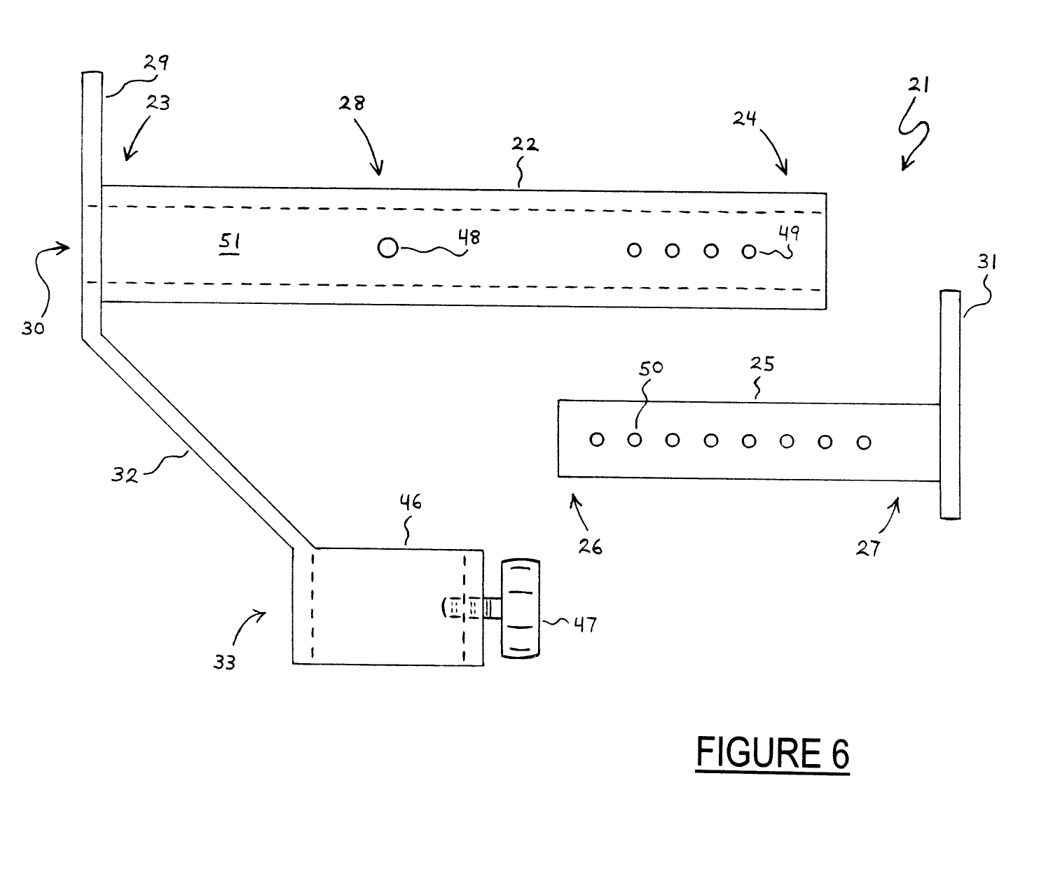

The crossbar assembly 21 is telescopically extendable and retractable. As best shown in FIG. 6, the crossbar assembly 21 generally has a first tubular section 22 and a second tubular section 25. The first tubular section 22 has both a first end 23 and a second end 24 that are substantially open and hollow. The second tubular section 25 has a first end 26 and a second end 27. The first tubular section 22 has one or more holes 49 defined in its second end 24, and the second tubular section 25 has one or more matching holes 50 defined in its first end 26. Provided with such holes 49 and 50, the crossbar assembly 21 can be adjustably lengthened and shortened by sliding the first end 26 of the second tubular section 25 back and forth in the hollow second end 24 of the first tubular section 22 until a desired crossbar length is attained and held with a pin. In this way, therefore, the crossbar assembly 21 can be made to fit and accommodate ladders of various different sizes.

For using the rack assembly 8 to support a ladder, the first tubular section 22 of the crossbar assembly 21 has an attachment section 28 along its length that is adapted for being releasably secured at the top end 16 of the top tubular section 15 of the stanchion assembly 12. When the attachment section 28 of the first tubular section 22 is properly secured at the top end 16 of the stanchion assembly's top tubular section 15, the first tubular section 22 is substantially perpendicular to the top tubular section 15, or the first tubular section 22 is generally horizontal with the ground. To further help support a ladder, the first end 26 of the second tubular section 25 of the crossbar assembly 21, as alluded to hereinabove, is adapted for being adjustably received and releasably captured in the second end 24 of the first tubular section 22.

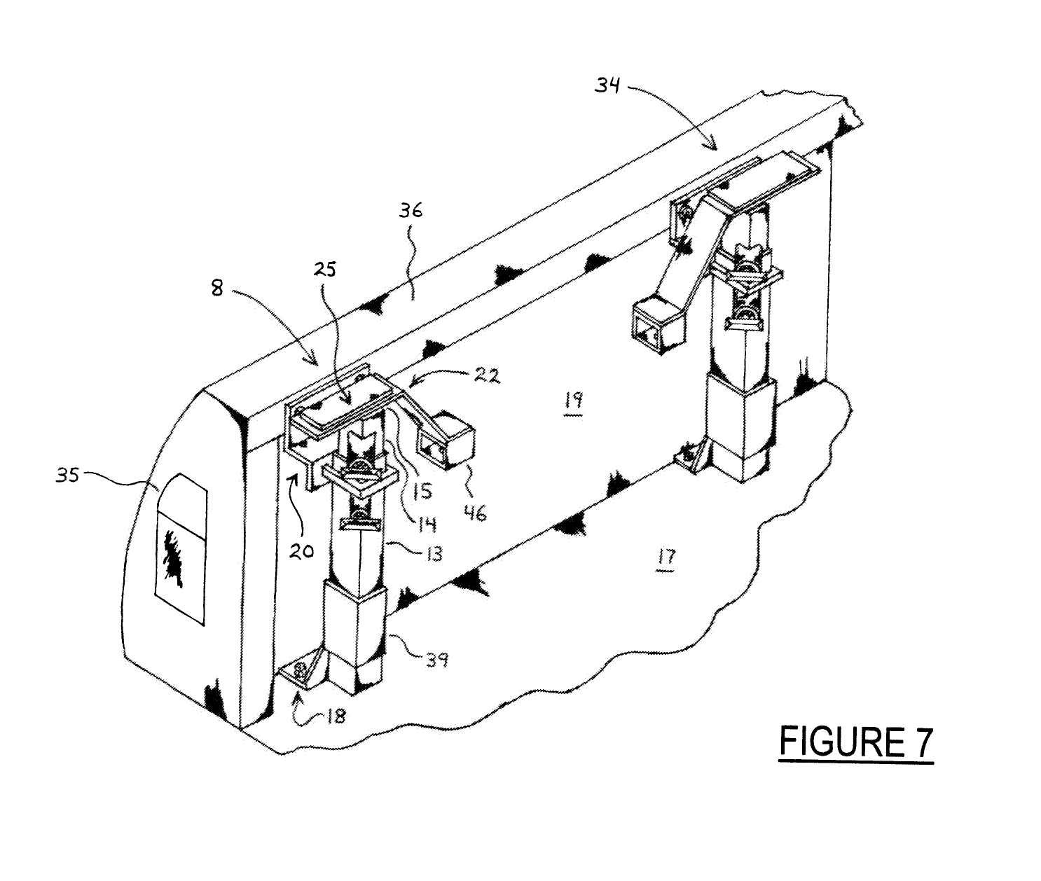

When, on the other hand, the rack assembly 8 is not being used to support a ladder, the stanchion assembly 12 can be telescopically collapsed down low as best shown in FIG. 7. To further facilitate reduced-volume and unitary storage of the overall rack assembly 8, the second end 24 of the first tubular section 22 of the crossbar assembly 21 is adapted for being received and removably retained in the top end 16 of the top tubular section 15 of the stanchion assembly 12. The first end 26 of the second tubular section 25 of the crossbar assembly 21, in turn, is similarly adapted for being received and removably retained in the first end 23 of the first tubular section 22.

In general, the bottom tubular section 13, the middle tubular section 14, the top tubular section 15, the first tubular section 22, and the second tubular section 25 of the overall rack assembly 8 are all substantially hollow. In addition, the bottom tubular section 13, the middle tubular section 14, the top tubular section 15, the first tubular section 22, and the second tubular section 25 all respectively have substantially rectangular or square cross sections.

Furthermore, as best shown in FIG. 7, the top tubular section 15 of the stanchion assembly 12 has a cross section that is smaller than that of the middle tubular section 14 so that the top tubular section 15 is received within the middle tubular section 14 when the stanchion assembly 12 is collapsed. Similarly, the middle tubular section 14 has a cross section that is smaller than that of the bottom tubular section 13 so that the middle tubular section 14 is received within the bottom tubular section 13 when the stanchion assembly 12 is collapsed.

Lastly, as best shown in FIGS. 1 and 6, the first end 23 of the crossbar assembly's first tubular section 22 has a flange 29 thereon for helping retain the ladder 9 on the crossbar assembly 21. As particularly shown in FIG. 6, the flange 29 has an opening 30 defined therethrough for permitting the first end 26 of the second tubular section 25 to be received and removably retained in the first end 23 of the first tubular section 22 during storage (see FIG. 7) of the rack assembly 8. The second end 27 of the second tubular section 25 similarly has a flange 31 thereon for also helping retain the ladder 9 on the crossbar assembly 21. As further shown in FIGS. 1 and 6, the flange 29 has a bent arm extension 32 with a distal end 33 that is structurally adapted into a collar 46 for being releasably secured to (i.e., around) the stanchion assembly's top tubular section 15 away from the top end 16.

In summary, when the rack assembly 8 is not being used to support a ladder, the rack assembly 8 can easily be collapsed and stored in a substantially unitary, reduced-volume configuration in the bed box of a truck. Furthermore, when the rack assembly 8 is particularly collapsed as shown in FIG. 7, the rack assembly 8 can easily be stored underneath a bed cover mounted on the top edge 36 of the truck's bed box 11.

While the present invention has been described in what is presently considered to be its most practical and preferred embodiment or implementation, it is to be understood that the invention is not to be limited to the particular embodiment disclosed hereinabove. On the contrary, the present invention is intended to cover various modifications and equivalent arrangements included within the spirit and scope of the claims appended hereinbelow, which scope is to be accorded the broadest interpretation so as to encompass all such modifications and equivalent structures as are permitted under the law.

What is claimed is:

1. A rack assembly for at least partially supporting a ladder in the bed box of a truck, said rack assembly comprising:
a telescopically erectable and collapsible stanchion assembly having a designated bottom tubular section and a designated top tubular section, said top tubular section having a designated top end that is substantially open;
at least one bracket assembly for mounting said bottom tubular section to said bed box; and
a telescopically extendable and retractable crossbar assembly having a designated first tubular section and a designated second tubular section, said first tubular section having both a first end and a second end that are substantially open, and said second tubular section having a first end and a second end;
wherein said first tubular section has a designated attachment section along its length that is adapted for being releasably secured at said top end of said top tubular section, and said first end of said second tubular section is adapted for being adjustably received and releasably captured in said second end of said first tubular section; and
wherein said second end of said first tubular section is adapted for being received and removably retained in said top end of said top tubular section, and said first end of said second tubular section is adapted for being received and removably retained in said first end of said first tubular section.

2. A rack assembly according to claim 1, wherein said top tubular section and said bottom tubular section are both substantially hollow, and said top tubular section has a cross section that is smaller than that of said bottom tubular section so that said top tubular section is received within said bottom tubular section when said stanchion assembly is collapsed.

3. A rack assembly according to claim 1, wherein said stanchion assembly further includes at least one designated middle tubular section.

4. A rack assembly according to claim 1, wherein said bottom tubular section, said top tubular section, said first tubular section, and said second tubular section are all substantially hollow.

5. A rack assembly according to claim 1, wherein said bottom tubular section, said top tubular section, said first tubular section, and said second tubular section all respectively have substantially rectangular cross sections.

6. A rack assembly according to claim 1, wherein said at least one bracket assembly includes a bracket assembly for mounting said bottom tubular section to the floor of said bed box.

7. A rack assembly according to claim 1, wherein said at least one bracket assembly includes a bracket assembly for mounting said bottom tubular section to a sidewall of said bed box.

8. A rack assembly according to claim 1, wherein said at least one bracket assembly includes a first bracket assembly for mounting said bottom tubular section to the floor of said bed box, and said at least one bracket assembly further includes a second bracket assembly for mounting said bottom tubular section to a sidewall of said bed box.

9. A rack assembly according to claim 1, wherein said first end of said first tubular section has a flange thereon for helping retain said ladder on said crossbar assembly, and said flange has an opening defined therethrough for permitting said first end of said second tubular section to be received and removably retained in said first end of said first tubular section.

10. A rack assembly according to claim 9, wherein said second end of said second tubular section has a complementary flange thereon for further helping retain said ladder on said crossbar assembly.

11. A rack assembly according to claim 9, wherein said flange has an arm extension with a distal end that is adapted for being releasably secured to said top tubular section away from said top end.

12. A rack assembly according to claim 1, wherein said attachment section of said first tubular section is particularly adapted for being releasably secured at said top end of said top tubular section so that said first tubular section is substantially perpendicular to said top tubular section.

13. A rack assembly for at least partially supporting a ladder in the bed box of a truck, said rack assembly comprising:
a telescopically erectable and collapsible stanchion assembly having a designated bottom tubular section, a designated middle tubular section, and a designated top tubular section, said top tubular section having a designated top end that is substantially open;
at least one bracket assembly for mounting said bottom tubular section to said bed box; and
a telescopically extendable and retractable crossbar assembly having a designated first tubular section and a designated second tubular section, said first tubular section having both a first end and a second end that are substantially open, and said second tubular section having a first end and a second end;
wherein said first tubular section has a designated attachment section along its length that is adapted for being releasably secured at said top end of said top tubular section, and said first end of said second tubular section is adapted for being adjustably received and releasably captured in said second end of said first tubular section; and
wherein said second end of said first tubular section is adapted for being received and removably retained in said top end of said top tubular section, and said first end of said second tubular section is adapted for being received and removably retained in said first end of said first tubular section.

14. A rack assembly according to claim 13, wherein:
said top tubular section, said middle tubular section, and said bottom tubular section are all substantially hollow;
said top tubular section has a cross section that is smaller than that of said middle tubular section so that said top tubular section is received within said middle tubular section when said stanchion assembly is collapsed; and
said middle tubular section has a cross section that is smaller than that of said bottom tubular section so that said middle tubular section is received within said bottom tubular section when said stanchion assembly is collapsed.

15. A rack assembly according to claim 13, wherein said at least one bracket assembly includes a first bracket assembly for mounting said bottom tubular section to the floor of said bed box, and said at least one bracket assembly further includes a second bracket assembly for mounting said bottom tubular section to a sidewall of said bed box.

16. A rack assembly according to claim 13, wherein said first end of said first tubular section has a flange thereon for helping retain said ladder on said crossbar assembly, and said flange has an opening defined therethrough for permitting said first end of said second tubular section to be received and removably retained in said first end of said first tubular section.

17. A rack assembly according to claim 16, wherein said second end of said second tubular section has a complementary flange thereon for further helping retain said ladder on said crossbar assembly.

18. A rack assembly according to claim 16, wherein said flange has an arm extension with a distal end that is adapted for being releasably secured to said top tubular section away from said top end.
